(19) United States
(12) Patent Application Publication
(10) Pub. No.: US 2009/0166115 A1
(43) Pub. Date: Jul. 2, 2009

(54) VEHICLE WITH STRUCTURE FOR IMPROVED ENGINE OUTPUT

(75) Inventors: Masami MIZUTANI, Iwata-shi (JP); Toshio IIZUKA, Iwata-shi (JP)

Correspondence Address: RABIN & Berdo, PC, 1101 14TH STREET, NW, SUITE 500, WASHINGTON, DC, 20005, US

(73) Assignee: Yamaha Hatsudoki Kabushiki Kaisha, Shizuoka-ken (JP)

(21) Appl. No.: 12/344,388

(22) Filed: Dec. 26, 2008

(30) Foreign Application Priority Data
Dec. 28, 2007 (JP) 2007-341417
Mar. 14, 2008 (JP) 2008-066233
Nov. 25, 2008 (JP) 2008-300072

(51) Int. Cl. B60K 13/02; F02M 35/02; B60G 7/00; B60K 13/04

(52) U.S. Cl. 180/68.3; 123/198 E; 180/296; 280/124.1

(57) ABSTRACT

A vehicle, such as a straddle-type vehicle, can include an engine, a catalyst and an air cleaner. The catalyst can be disposed in an expansion chamber of the vehicle. At least a part of the air cleaner can be disposed above a swing arm of the vehicle, and at least a part of the expansion chamber can be disposed below the swing arm. The air cleaner can further be disposed to the rear of a shock absorber of the vehicle. Thus, the influence of heat from the catalyst and the engine on the air cleaner can be reduced. Consequently, efficiency of air induction into the engine can be increased, thereby improving engine output.

### CROSS-REFERENCE TO RELATED APPLICATIONS

This application claims priority under 35 U.S.C. §119 from Japanese Patent Application No. 2008-300072, filed Nov. 25, 2008, Japanese Patent Application No. 2007-341417, filed Dec. 28, 2007, and Japanese Application No. 2008-066233, filed Mar. 14, 2008. The entirety of each of the foregoing applications is incorporated herein by reference.

### BACKGROUND OF THE INVENTION

1. Technical Field

Embodiments of the present invention relate to generally to a vehicle, such as a straddle-type vehicle. The vehicle can include an air cleaner coupled to an engine, and a catalyst for purifying exhaust gas discharged from the engine.

2. Background Art

Conventionally, a configuration wherein an air cleaner is disposed above an engine is widely used in straddle-type vehicles such as motorcycles. For example, JP-A-Sho 58-152115 discloses a construction for a straddle-type vehicle wherein an air cleaner is disposed above a crankcase provided in a lower part of the engine and in the rear of a cylinder block.

An exhaust pipe of the engine typically includes a catalyst for purifying exhaust gas. For example, JP-A-Sho 58-152115 further discloses a catalyst disposed in the exhaust pipe disposed below the engine.

### SUMMARY OF THE INVENTION

Embodiments of the present invention relate to a vehicle with a structure for improved engine output. The vehicle can be a straddle-type vehicle, such as a motorcycle. The vehicle can include an engine, a catalyst and an air cleaner. The catalyst can be disposed in an expansion chamber of the vehicle, thereby reducing the influence of heat from the catalyst on the air cleaner. At least a part of the air cleaner can be disposed above a swing arm of the vehicle, and at least a part of the expansion chamber can be disposed below the swing arm. Thus, the air cleaner and the expansion chamber can be sufficiently separated from each other that the influence of heat from the catalyst on the air cleaner can be further reduced. The air cleaner can further be disposed to the rear of a shock absorber of the vehicle. Thus, the air cleaner can be disposed in a position sufficiently remote from the engine that the influence of heat from the engine on the air cleaner can be reduced. Consequently, efficiency of air induction into the engine can be increased, thereby improving engine output.

More particularly, in embodiments of the invention, the straddle-type vehicle can comprise an engine, a vehicle body frame supporting the engine, a swing arm having a front part disposed to a rear of the engine and swingably supported by the vehicle body frame, and a rear part supporting a rear wheel. The straddle-type vehicle can further comprise a shock absorber having a lower part supported by the swing arm, and an upper part supported by the vehicle body frame and provided in front of the lower part.

The straddle-type vehicle can still further comprise an air cleaner disposed to a rear of the shock absorber and connected to the engine, and an expansion chamber provided below the shock absorber and including a catalyst for purifying exhaust gas discharged from the engine. At least a part of the air cleaner can be provided above the swing arm, and at least a part of the expansion chamber can provided below the swing arm.

### BRIEF DESCRIPTION OF THE DRAWINGS

FIG. 1 is a left side view of a vehicle, for example, a motorcycle, in accordance with a first exemplary embodiment of the present invention;

FIG. 2 is a right side view of the motorcycle in accordance with the first exemplary embodiment;

FIG. 3 is a partially enlarged perspective view showing structures of a swing arm, a shock absorber, and an air cleaner in accordance with the first exemplary embodiment;

FIG. 4 is a perspective view of an exhaust system in accordance with the first exemplary embodiment;

FIG. 5 is a perspective view showing an inner construction of an exhaust chamber in accordance with the first exemplary embodiment;

FIG. 6 is a side view showing a general construction of a motorcycle in accordance with a second exemplary embodiment of the present invention;

FIG. 7 is a view as seen from a direction of arrow P in FIG. 8;

FIG. 8 is a side view of a vicinity of a main stand in a traveling state of the motorcycle in accordance with the second exemplary embodiment shown in FIG. 6 as seen from one side;

FIG. 9 is a side view of a vicinity of the main stand in the traveling state of the motorcycle in accordance with the second exemplary embodiment shown in FIG. 6 as seen from the other side;

FIG. 10 is a plan view of a vicinity of an exhaust chamber and the main stand in the traveling state of the motorcycle in accordance with the second exemplary embodiment shown in FIG. 6;

FIG. 11 is a side view of a vicinity of the main stand in a standing-still state of the motorcycle in accordance with the second embodiment shown- in FIG. 6 as seen from one side; and

FIG. 12 is a left side view of a rear part of the motorcycle in accordance with the second exemplary embodiment.

### DETAILED DESCRIPTION OF THE INVENTION

The invention will now be described in more detail by way of example with reference to the embodiments shown in the accompanying Figures. It should be kept in mind that the following described embodiments are only presented by way of example and should not be construed as limiting the inventive concept to any particular physical configuration. It should further be understood that “exemplary” as used herein means “serving as an example, instance or illustration.” Any aspect referred to herein as “exemplary” is not necessarily to be construed as preferred over other aspects.

Further, if used and unless otherwise stated, the terms “upper,” “lower,” “front,” “back,” “over,” “under,” and similar such terms are not to be construed as limiting the invention to a particular orientation. Instead, these terms are used only on a relative basis.

Moreover, any term of degree used herein, such as “substantially”, “essentially” and “nearly”, means a reasonable amount of deviation of the modified word is contemplated such that the end result is not significantly changed. For example, such terms can be construed as allowing a deviation of at least 5% of the modified word if this deviation would not negate the meaning of the word the term of degree modifies.

### First Exemplary Embodiment

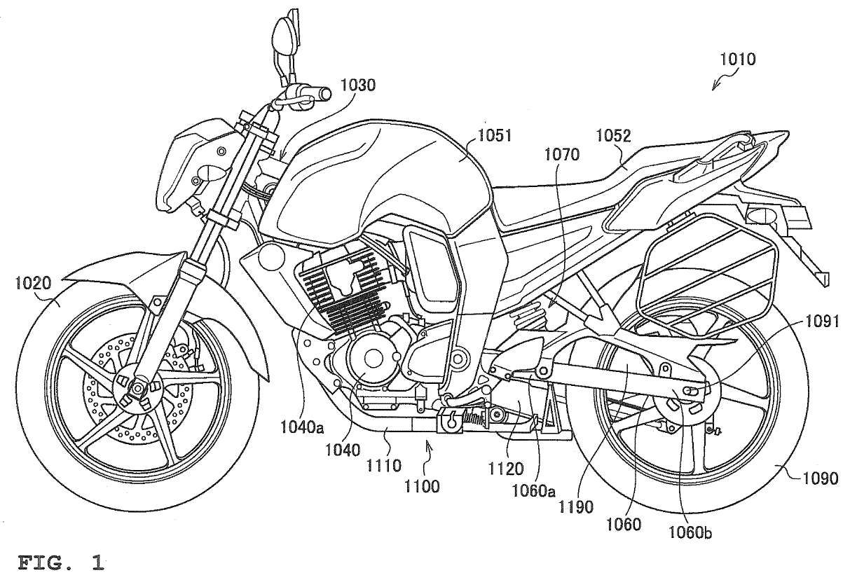

FIG. 1 is a left side view of a vehicle 1010, specifically, a motorcycle, according to a first exemplary embodiment of the invention. As shown in FIG. 1, the motorcycle 1010 can include a front wheel 1020 and a rear wheel 1090. The motorcycle 1010 can further include an engine 1040 that can generate a driving force to drive the rear wheel 1090. The engine 1040 can be mounted on a vehicle body frame 1030 forming a framework of the motorcycle 1010. The engine 1040 can be, for example, a single-cylinder four-cycle engine. The engine 1040 can be air-cooled and have a comparatively small displacement. It should be understood that embodiments of the invention are not limited in respect of the kind of engine used, and that the use of other kinds of engines is possible.

A fuel tank 1051 for storing fuel can be disposed above the engine 1040. A seat 1052 for seating a rider can be disposed in the rear of the fuel tank 1051.

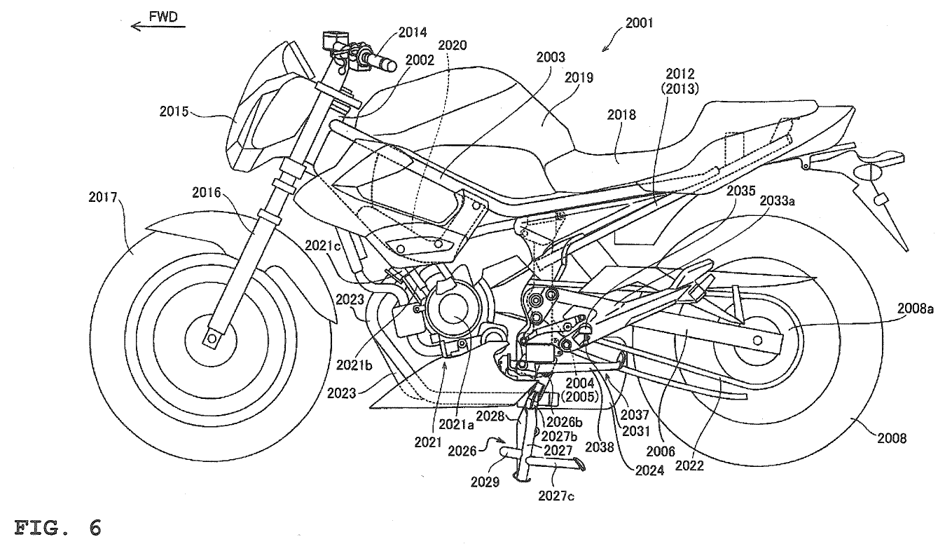

The rear wheel 1090 can be supported by a swing arm 1060 that is swingable in a generally vertical direction. It should be understood that as used herein, “vertical” or “vertical direction” refers, for example, to a substantially up-and-down direction or arrangement or posture, with respect to the ground, for the motorcycle 1010 or a motorcycle 2001 (see FIG. 6) or components thereof, in a view as in FIG. 1 or FIG. 6, for example, which can be assumed by the motorcycle 1010 or 2001 when it is standing still or traveling in a substantially upright position.

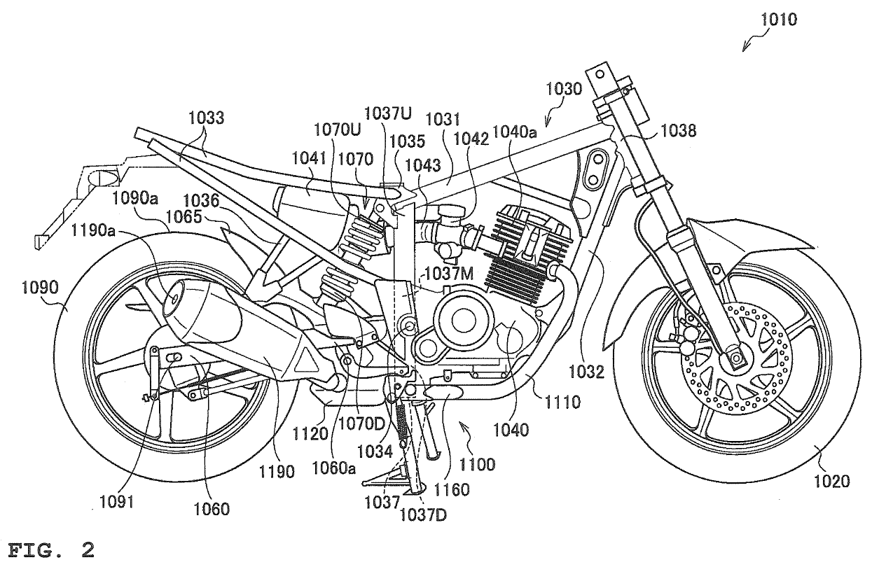

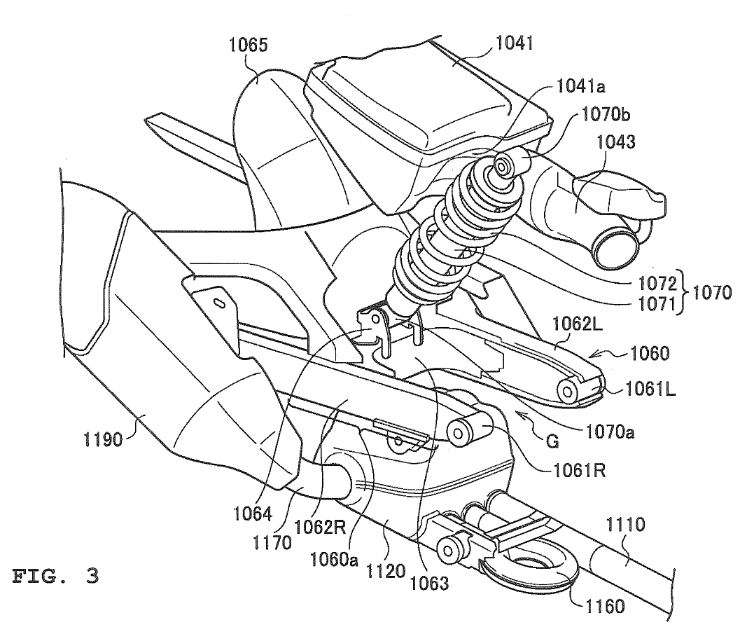

The swing arm 1060 can be provided to the rear of the engine 1040. The swing arm 1060 can include a pair of arms 1062L and 1062R (see FIG. 3) for rotatably supporting an axle 1091 of the rear wheel 1090. The vehicle body frame 1030 can include a pivot part 1034 (see FIG. 2) for swingably supporting the swing arm 1060.

A shock absorber 1070 for absorbing shocks to the rear wheel 1090 can be coupled to a front part 1060a of the swing arm 1060. A rear part 1060b of the swing arm 1060 can rotatably support the rear wheel 1090. The shock absorber 1070 can extend upward from the front part 1060a of the swing arm 1060. In the first exemplary embodiment, the swing arm 1060 and the shock absorber 1070 can form a suspension unit on which the rear wheel 1090 is suspended. The shock absorber 1070 can include a lower part 1070D (see FIG. 2) supported by the front part 1060a of the swing arm 1060, and an upper part 1070U (see FIG. 2) supported by the vehicle body frame 1030 and provided in front of the lower part 1070D.

An exhaust system 1100 can be coupled to the engine 1040. In the exhaust system 1100, an exhaust pipe 1110 can be coupled to a cylinder head 1040a of the engine 1040.

FIG. 2 is a right side view of the motorcycle 1010 (from a perspective of rider, for example, seated on the seat 1052 and facing forward toward the front wheel 1020). It should be understood that the motorcycle 1010 can include a vehicle body cover, not shown in FIG. 2, which would ordinarily cover at least a part of the motorcycle 1010 in the right side view.

As shown in FIG. 2, the vehicle body frame 1030 can include a main frame 1031, a down tube 1032, seat rails 1033, and a center frame 1037. The main frame 1031 -can extend rearward from a head pipe 1038. The down tube 1032 can extend downwardly obliquely rearward from the head pipe 1038.

The seat rails 1033 can be coupled to the main frame 1031 via a bracket 1035. Stays 1036 for supporting a silencer 1190 can be coupled to the seat rail 1033.

The center frame 1037 can extend along a substantially vertical direction with respect to the motorcycle 1010, to the rear of the engine 1040. For example, the center frame 1037 can be positioned in a substantially central (with respect to an overall front-to-rear or rear-to-front length of the motorcycle 1010 as seen, for example, in the views of FIG. 1 or FIG. 2) part of the motorcycle 1010,. The center frame 1037 can include an upper part 1037U for supporting the shock absorber 1070, an intermediate part 1037M for supporting the swing arm 1060, and a lower part 1037D for supporting an exhaust chamber 1120. The shock absorber 1070 can be supported by the upper part 1037U via the bracket 1035.

The pivot part 1034 can be provided in the intermediate part 1037M of the center frame 1037. In other words, the center frame 1037 can pivotably support the swing arm 1060. The motorcycle 1010 can comprise a single center frame 1037, or a plurality of center frames 1037. In the first exemplary embodiment, the center frame and a part of the bracket 1035 can form a vertical frame part.

An upper end 1070b (see FIG. 3) of the shock absorber 1070 can be coupled (e.g., directly coupled, with no link mechanism interposed therebetween) to the bracket 1035. A lower end 1070a (see FIG. 3) of the shock absorber 1070 can be coupled (e.g., directly coupled) to the swing arm 1060.

An air cleaner 1041 for purifying air to be supplied to the engine 1040 can be disposed between the right and left seat rails 1033. The air cleaner 1041 can be disposed to the rear of the shock absorber 1070, and above the swing arm 1060. The air cleaner 1041 can be disposed to the rear of the center frame 1037.

More particularly, the air cleaner 1041 can be disposed adjacent to or adjoining the upper end 1070b of the shock absorber 1070 to the rear of the upper end 1070b (or the upper part 1070U). At least a part of the air cleaner 1041 can be provided below the upper part 1070U of the shock absorber 1070 and below an upper end 1 090a of the rear wheel 1090.

Still referring to FIG. 2, the air cleaner 1041 can be coupled to the cylinder head 1040a via an intake duct 1043. A carburetor 1042 for injecting fuel can be mounted on the intake duct 1043. Air from the air cleaner 1041 can be mixed with fuel by the carburetor 1042, and thereafter introduced into the engine 1040.

The exhaust system 1100 can include the exhaust pipe 1110, an exhaust chamber 1120 and the silencer 1190. The exhaust chamber 120 can be provided below the shock absorber 1070 and communicatively connected to the exhaust pipe 1110. The silencer 1190 can be communicatively connected to the exhaust chamber 1120 via a connecting pipe 1170 (see FIG. 3). Thus, the exhaust chamber 1120 can be provided between the engine 1040 and the silencer 1190.

The exhaust chamber 1120 can be disposed below the suspension unit formed by the swing arm 1060 and the shock absorber 1070. More specifically, the exhaust chamber 1120 can be provided between the vehicle body frame 1030 and the rear wheel 1090 below the swing arm 1060. The exhaust system 1100 can include a reflux pipe 1160 communicatively connected to a lower part of the exhaust chamber 1120. The reflux pipe 1160 can reflux exhaust gas to the exhaust chamber 1120. The reflux pipe 1160 can extend from the exhaust chamber 1120 to a part below a rear part of the engine 1040.

Exhaust gas discharged from the engine 1040 via the exhaust pipe 1110 can expand in the exhaust chamber 1120. Thus, in the first exemplary embodiment, the exhaust chamber 1120 can form an expansion chamber.

The silencer 1190 can be positioned at a rear end of the exhaust system 1100. For example, the silencer 1190 can disposed on the right side (as seen, for example, from the perspective of a rider seated on the seat 1052 and facing the front wheel 1020) of the rear wheel 1090. Exhaust gas can be discharged from a rear end 1190a of the silencer 1190.

The exhaust chamber 1120 and the silencer 1190 can reduce exhaust noise generated by the engine 1040. Because the exhaust chamber 1120 can be provided, the silencer 1190 can be made smaller in size than would be the case if the exhaust chamber 1120 were not provided. Thus, the overall length of the exhaust system 1100 can be shorter compared to the case where the exhaust chamber 1120 is not provided.

Suspension Unit and Air Cleaner As noted above, a suspension unit according to embodiments of the invention can include the swing arm 1060 and the shock absorber 1070. FIG. 3 is a partially enlarged perspective view showing aspects of the swing arm 1060 and the shock absorber 1070. FIG. 3 further illustrates aspects of the air cleaner 1041.

As shown in FIG. 3, the swing arm 1060 can include supported parts 1061L and 1061R, the arms 1062L and 1062R, a bridge 1063, and a rear fender 1065. The rear fender 1065 can cover a part of the rear wheel 1090.

The supported parts 1061L and 1061R can be supported by the vehicle body frame 1030. The arms 1062L and 1062R can be integral with the supported parts 1061L and 1061R and rotatably support the axle 1091 of the rear wheel 1090.

The bridge 1063 can couple the arms 1062L and 1062R together. A gap G can be formed between the supported parts 1061L and 1061R and the bridge 1063.

A bracket 1064 can be mounted on the bridge 1063. The lower end 1070a of the shock absorber 1070 can be coupled to the bracket 1064.

The exhaust chamber 1120 can be disposed to the rear of the supported parts 1061L and 1061R, and below a part at which the shock absorber 1070 and the swing arm 1060 are coupled together. Specifically, the exhaust chamber 1120 can be disposed below the gap G and the bridge 1063.

The shock absorber 1070 can include a damper 1071 and a coil spring 1072. The damper 1071 can absorb shocks to the rear wheel 90 by reciprocal motion. The damper 1071 can, for example, be formed in the shape of a cylinder. The damper 1071 can be disposed such that a component of a direction in which it is arranged is substantially vertical (e.g., substantially or approximately parallel to a direction of the center frame 1037 as described above). The coil spring 1072 can be disposed around an outer periphery of the damper 1071.

A recess 1041a curved along a shape of the outer periphery of the shock absorber 1070 can be formed at a front end of the air cleaner 1041. The intake duct 1043 can be disposed on the left side (e.g., from the perspective of a forward-facing rider as described above) of the recess 1041a. The air cleaner 1041 can be formed to become thinner in a rearward direction, to correspond to an interval between the upper and lower seat rails 1033.

### Exhaust System

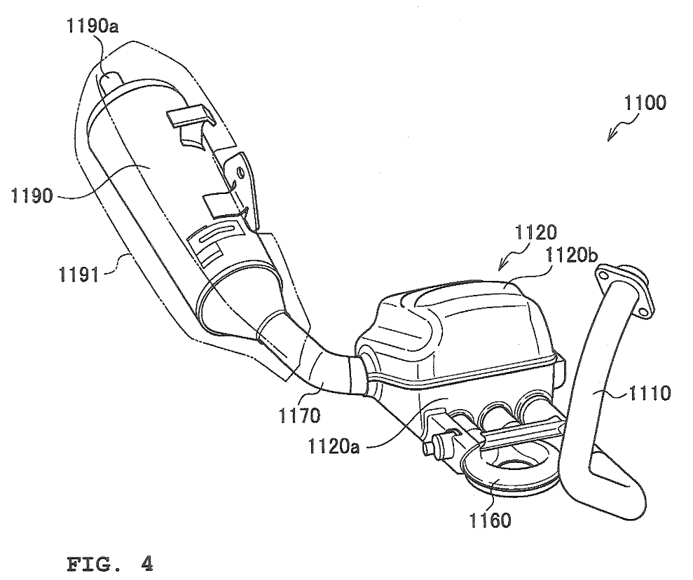

FIG. 4 is a perspective view of the exhaust system 1100. As shown in FIG. 4, the exhaust chamber 1120 can be communicatively connected to the exhaust pipe 11 10. The reflux pipe 1160 can be communicatively connected to a front end 11 20a of the exhaust chamber 1120. A protrusion 1120b protruding upward can be formed on the exhaust chamber 1120. The protrusion 1120b can be positioned below the gap G.

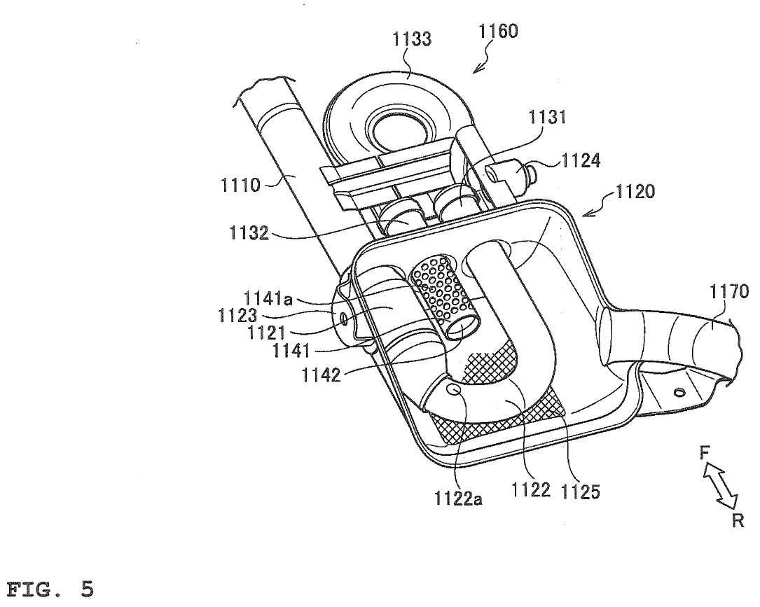

A mounting part 1123 (see FIG. 5) can be provided on the exhaust chamber 1120. Furthermore, a mounting part 1124 (see FIG. 5) can be provided on the reflux pipe 160. The exhaust chamber 1120 can be mounted on the vehicle body frame 1030 using the mounting parts 1123 and 1124.

The connecting pipe section 1170 can be communicatively connected to the exhaust chamber 1120. The silencer 1190 can be communicatively connected to the connecting pipe 1170. A protector 1191 can be provided on the outside of the silencer 1190.

FIG. 5 is a perspective view of the exhaust chamber 1120 and the reflux pipe 1160 which can form the expansion chamber according to the first exemplary embodiment. FIG. 5 illustrates an inner construction of the exhaust chamber 1120. In FIG. 5, on the lower right-hand side, “F” indicates “Front” and “R” indicates “Rear.”

As shown in FIG. 5, a catalyst 1121 for purifying exhaust gas discharged from the engine 1040 can be disposed in the exhaust chamber 1120. The exhaust chamber 1120 can, for example, be box-shaped, but other shapes are possible for the exhaust chamber 1120. The catalyst 1121 can be coupled to the exhaust pipe 1110. Exhaust gas having passed through the exhaust pipe 1110 can be guided into the catalyst 1121.

A communication section 1122 can be communicatively connected to the catalyst 1121. The communication section 1122 can be communicatively connected to the reflux pipe 1160, specifically, to a first pipe section 1131.

An opening 1122a can be formed in the communication section 1122. For example, the opening 1122a can be formed in the immediate rear of the catalyst 1121. The opening 1122a can be formed in an upper surface of the communication section 1122. An opening (not shown) similar to the opening 1122a can be formed in a lower surface of the communication section 1122 facing the opening 1122a. In other words, two openings can be formed in the communication section 1122. A mesh part 1125 can be provided on an inner bottom surface of the exhaust chamber 1120.

The reflux pipe 1160 can include the first pipe section 1131, a second pipe section 1132, and a folded pipe section 1133. The first pipe section 1131 can extend from the exhaust chamber 1120 to the front of the motorcycle 1010 (direction F in FIG. 2).

The second pipe section 1132 can be communicatively connected to the first pipe section 1131 via the folded pipe section 1133 and to the exhaust chamber 1120. The second pipe section 1132 can be communicatively connected to the exhaust chamber 1120 from the front side of the motorcycle 1010. In the first exemplary embodiment, the exhaust pipe 1110 can be disposed generally or substantially in parallel with the first pipe section 1131 and the second pipe section 1132. In other words, the exhaust pipe 1110 can also be communicatively connected to the exhaust chamber 1120 from the front side of the motorcycle 1010.

The folded pipe section 1133 can couple the first pipe section 1131 and the second pipe section 1132 together. In other words, exhaust gas having passed through the first pipe section 1131 can be guided to the second pipe section 1132 via the folded pipe section 1133.

The second pipe section 1132 can include a protrusion 1141 protruding into the exhaust chamber 1120. Exhaust gas discharged from the communication section 1122 to the reflux pipe 1160 can be discharged from the protrusion 1141 into the exhaust chamber 1120. Exhaust gas discharged from the protrusion 1141 can expand in the exhaust chamber 1120. Thus, exhaust chamber 1120 can function as an expansion chamber.

Exhaust holes 1141a can be formed in an outer periphery of the protrusion 1141. Each exhaust hole 1141a can be circular, for example, though other shapes are possible for the exhaust holes 1141a. A large number of exhaust holes 1141 can be formed in the outer periphery of the protrusion 1141. Exhaust gas can be discharged into the exhaust chamber 120 via the exhaust holes 1141a.

In the first exemplary embodiment, an end of the protrusion 1141 can be sealed. For example, a cap 1142 can be mounted on the end of the protrusion 1141.

In view of the foregoing discussion, embodiments of the invention have a number of advantages. For example, the embodiments can facilitate a reduction in the influence of heat generated by the catalyst 1121 and the engine 1040 on the air cleaner 1141. Thus, efficiency of air induction into the engine, and consequently engine output, can be improved.

The advantages can be realized at least in part by the above-described structures. For example, the catalyst 1121, which emits heat, can be disposed in the exhaust chamber 1120. The exhaust chamber 1120 can function as an expansion chamber, as described above. Because the catalyst 1121 can be disposed in the expansion chamber, it can be made more difficult for heat emitted by the catalyst 1121 to be transmitted to the outside of the expansion chamber.

As another example, the air cleaner 1041 can be disposed to the rear of the shock absorber 1070, and above the swing arm 1060. In addition, the exhaust chamber 1120 can be disposed below the shock absorber 1070 and the swing arm 1060. Accordingly, the air cleaner 1041 and the exhaust chamber 1120 can be sufficiently separated from each other that the influence of heat from the catalyst 1121 on the air cleaner 1141 can be reduced. Further, the swing arm 1060 and the shock absorber 1070 can be disposed to the rear of the engine 1040. The air cleaner 1041 can be disposed to the rear of the center frame 1037 positioned to the rear of the engine 1040. Thus, the air cleaner 1041 can be disposed in a position sufficiently remote from the engine 1040 that the influence of heat from the engine 1040 on the air cleaner 1041 can be reduced.

Further, in the first exemplary embodiment, the air cleaner 1041 can be disposed to the rear of the upper end 1070b of the shock absorber 1070. The air cleaner 1041 can be adjacent to or adjoin the upper end 1070b of the shock absorber 1070. Thus, the air cleaner 1041 can be disposed in a position sufficiently remote from the catalyst 1121 and the engine 1040 to allow further reduction in influence of heat emitted by the engine 1040 and the catalyst 1121 on the air cleaner 1041.

Still further, in the first exemplary embodiment, the exhaust chamber 1120 can be disposed below the swing arm 1060. Accordingly, the exhaust chamber 1120 can be remotely positioned from the air cleaner 1041, to allow further reduction in influence of heat emitted by the catalyst 1121 in the exhaust chamber 1120 on the air cleaner 1041.

Still further, in the first exemplary embodiment, the recess 1041a curved along the shape of the outer periphery of the shock absorber 1070 can be formed at the front end of the air cleaner 1041. Therefore, a sufficient capacity of the air cleaner 1041 can be secured and at the same time the air cleaner 1041 can be disposed to be adjacent to or adjoin the shock absorber 1070. Accordingly, reduction in influence of heat emitted by the engine 1040 and the catalyst 1121 on the air cleaner 1041 can be made compatible with prevention of a size increase of the motorcycle 1010.

Still further, in the first exemplary embodiment, the intake duct 1043 extending from the air cleaner 1041 toward the engine 1040 can be disposed on the left side of the recess 1041a. Therefore, interference between the intake duct 1043 and the shock absorber 1070 can be prevented and at the same time the air cleaner 1041 can be disposed to be adjacent to or adjoin the shock absorber 1070.

Still further, in the first exemplary embodiment, the lower end 1070a of the shock absorber 1070 can be directly coupled to the swing arm 1060 with no link mechanism interposed therebetween. Therefore, the shock absorber 1070 does not project below the swing arm 1060 when the swing arm 1060 swings. Accordingly, the exhaust chamber 1120 can be disposed close to the swing arm 1060 without interference between the exhaust chamber 1120 and the swing arm 1060.

Still further, in the first exemplary embodiment, the reflux pipe 1160 can be provided outside the exhaust chamber 1120. This can facilitate securing an exhaust passage of a required length. Moreover, this can increase the substantial capacity of the exhaust chamber 1120 compared to the case wherein an exhaust pipe of a length equivalent to the reflux pipe 1160 is disposed in the exhaust chamber 1120. Accordingly, a reduction in exhaust noise can be achieved.

Still further, in the first exemplary embodiment, the swing arm 1060 can include the pair of arms 1062L and 1062R and the bridge 1063 coupling the pair of arms 1062L and 1062R together. The lower end 1070a of the cushion unit 1070 can be coupled to the bridge 1063. Thus, the heavy cushion unit 1070 can be disposed in the central position of the vehicle, and traveling stability of the motorcycle 1010 can be enhanced. This allows absorption of shocks to the rear wheel 1090 by the single cushion unit 1070.

### Second Exemplary Embodiment

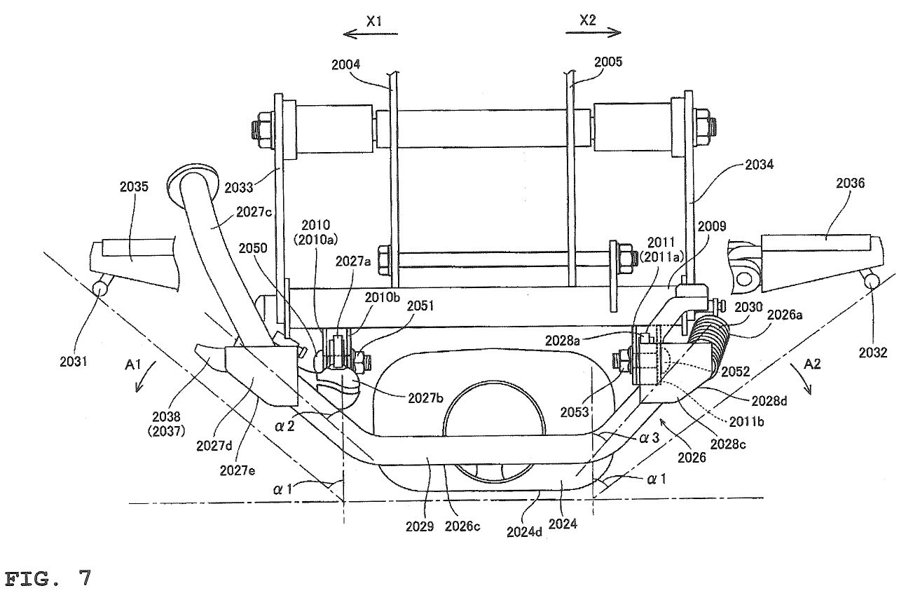

FIG. 6 is a side view showing a general construction of a vehicle 2001, such as a motorcycle, in accordance with a second exemplary embodiment of the present invention. FIGS. 7 through 12 are drawings to illustrate details of structures of an exhaust chamber and a vicinity of a main stand of the motorcycle in accordance with the second embodiment shown in FIG. 6. In the figures, “FWD” (see, e.g., the upper left-hand side of FIG. 6) indicates the forward traveling direction of the motorcycle. A construction of a motorcycle 2001 in accordance with the second exemplary embodiment will be described hereinafter in detail with reference to FIGS. 6 through 12.

In the motorcycle 2001, as shown in FIG. 6, a main frame 2003 extending in the front-to-rear or rear-to-front direction can be disposed to the rear of a head pipe 2002. As shown in FIGS. 6 and 7, a pair of pivot supporting plates 2004 and 2005 extending downward can be provided in a vicinity of a substantially central (e.g., with respect to an overall front-to-rear or rear-to-front length of the motorcycle 2001 as seen, for example, in the view of FIG. 6) part of the main frame 2003.

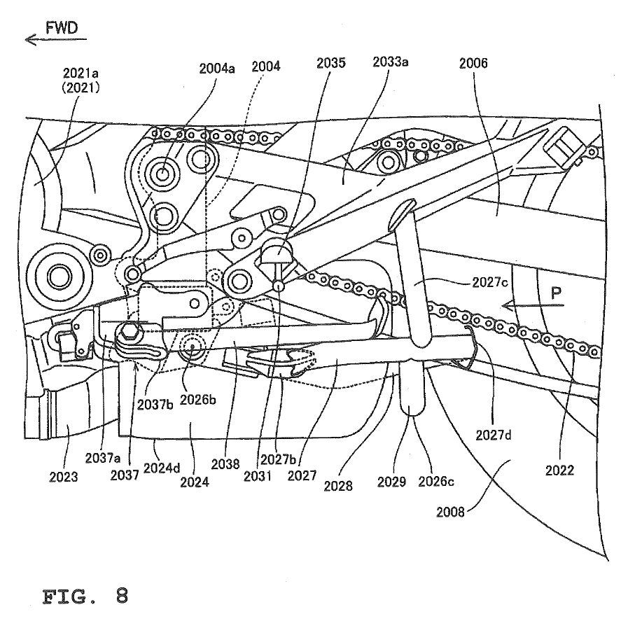

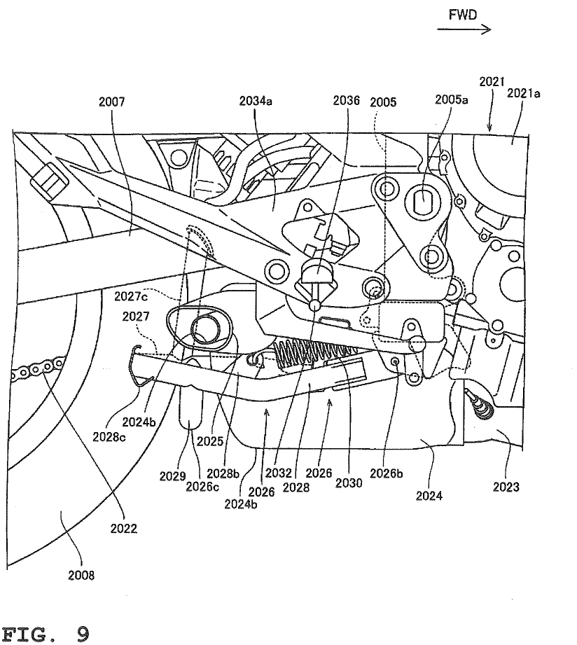

As shown in FIG. 8, a pivot part 2004a for swingably supporting a swing arm 2006 around a vicinity of a front end of the swing arm 2006 can be provided on the pivot supporting plate 2004. As shown in FIG. 9, a pivot part 2005a for supporting a swing arm 2007 swingably around a vicinity of a front end of the swing arm 2007 can be provided on the pivot supporting plate 2005. A rear wheel 2008 can be rotatably mounted on a vicinity of a rear end of each of the swing arms 2006 (see FIG. 8) and 2007 (see FIG. 9). As shown in FIG. 7, a connecting member 2009 extending in the vehicle width direction (corresponding to arrows X1 and X2, indicating a direction substantially transverse to a front-to-rear or rear-to-front direction as illustrated, for example, in FIG. 6) can be mounted on a lower end of each of the pair of pivot supporting plates 2004 and 2005. Referring to FIG. 7, each of a pair of mounting members 2010 and 2011 can be mounted on a lower surface of the connecting member 2009 to extend downward. Each of the mounting members 2010 and 2011 can be provided for rotatably mounting a main stand 2026. The main stand 2026 can include a pair of support legs for supporting the vehicle 2001 in a stationary of standing-still state, and a coupling part coupling the pair of the support legs together. The main stand 2026 can be capable of being positioned into a moving or traveling state. The main stand 2026 is described in more detail further on.

Returning now to FIG. 6, a back stay 2012 can be mounted between a rear part of the main frame 2003 and the pivot supporting plate 2004. A back stay 2013 can be mounted between the rear part of the main frame 2003 and the pivot supporting plate 2005. A vehicle body frame can be formed by the head pipe 2002, the main frame 2003, the pivot supporting plates 2004 and 2005, the connecting member 2009 (see FIG. 7), and the back stays 2012 and 2013.

Handlebars 2014 can be rotatably mounted on an upper part of the head pipe 2002. A headlight 2015 can be provided in front of the head pipe 2002. A pair of front forks 2016 having suspensions for absorbing shocks in the vertical direction can be disposed below the head pipe 2002. A front wheel 2017 can be rotatably mounted on lower ends of the pair of the front forks 2016.

A seat 2018 can be disposed in an upper part in the rear of the main frame 2003. A fuel tank 2019 can be disposed in front of the seat 2018.

An engine retaining member 2020 can be mounted below the main frame 2003. An engine 2021 can be suspended on the engine retaining member 2020. The engine 2021 can be a parallel four-cylinder engine in which four cylinders (not shown) are arranged in the vehicle width direction. It should be understood that embodiments of the invention are not limited in respect of the kind of engine used, and the use of other kinds of engines is possible. The engine 2021 can include a crankcase 2021a in which a crankshaft (not shown) is disposed to extend in the vehicle width direction, and a cylinder block 2021b extending upwardly forward from an upper part of the crankcase 2021a. The four cylinders (not shown) can be arranged in the crankcase 2021a in the vehicle width direction. A cylinder head 2021c can be disposed in an upper part of the cylinder block 2021b.

A drive chain 2022 for transmitting driving force generated in the engine 2021 to the rear wheel 2008 can be guided out from a rear part of the crankcase 2021a. The drive chain 2022 can be guided out to extend rearward and meshed with a driven sprocket 2008a provided in the rear wheel 2008.

One end of each of four exhaust pipes 2023 for guiding out exhaust gas can be mounted on a front side of the cylinder head 2021c. Each of the exhaust pipes 2023 can extend downward from the front side of the cylinder head 2021c, thereafter curve rearward, and extend to a lower part in the rear of the engine 2021.

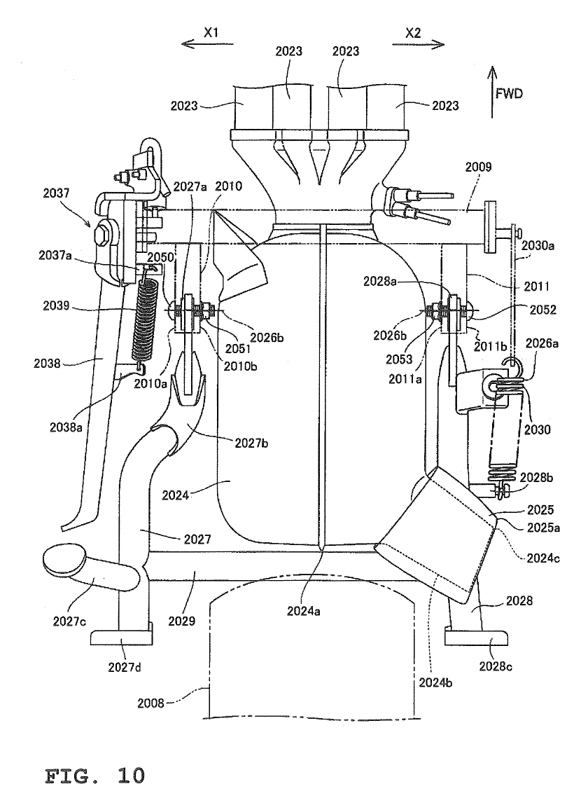

In the second exemplary embodiment, as shown in FIGS. 8 and 10, the other end of each of the four exhaust pipes 2023 can be connected to a single exhaust chamber 2024. As shown in FIG. 6, the exhaust chamber 2024 can be disposed between the engine 2021 and the rear wheel 2008, and can have a function of purifying exhaust gas discharged from the engine 2021 and of reducing exhaust noise. The exhaust chamber 2024 can form an expansion chamber in the second exemplary embodiment.

The exhaust chamber 2024 can be disposed such that its rear end 2024a (see FIG. 10) is positioned in front of the rear wheel 2008 and a prescribed interval is interposed between the rear end 2024a and a front part of the rear wheel 2008. The interval between the front part of the rear wheel 2008 and the rear end 2024a (see FIG. 10) of the exhaust chamber 2024 can be configured such that an upper part of the interval is wider than a lower part of the interval (e.g., due to an upward curvature of the rear wheel 2008 out of the plane of FIG. 10).

In the second exemplary embodiment, as shown in FIG. 10, an exhaust outlet 2024b for discharging exhaust gas can be mounted on a rear part of the exhaust chamber 2024a. The exhaust outlet 2024b can extend rearward substantially in the direction of arrow X2. As shown in FIG. 9, the exhaust outlet 2024b can be disposed between the main stand 2026 (see, e.g., FIG. 6) in a traveling state that will be described later and the swing arm 2007, and thus can be formed such that exhaust gas discharged from the exhaust outlet 2024b does not directly hit the rear wheel 2008. A cover member 2025 can be provided to cover an outer periphery of the exhaust outlet 2024b. As shown in FIG. 10, an end of the exhaust outlet 2024b can be housed in the cover member 2025 so as not to project out from the cover member 2025 in a plan view.

Still referring to FIG. 10, an end (outermost part) 2024c of the exhaust outlet 2024b can be positioned further in the direction of arrow X1 (e.g., further inward or leftward in the view of FIG. 10) than an outermost part 2026a of the main stand 2026, described in more detail further on. Further, similarly to the exhaust outlet 2024b, an end 2025a of the cover member 2025 can be positioned further in the direction of arrow X1 than the outermost part 2026a in of the main stand 2026.

In the second exemplary embodiment, the main stand 2026 can have a rotational center or axis 2026b on either side of the exhaust chamber 2024 in the vehicle width direction (directions of arrows X1 and X2). The main stand 2026 may be referred to herein as a “first stand.” The main stand 2026 can be formed to be capable of being positioned into a traveling state, for example by being turned or rotated upward. For example, the vehicle 2001 can travel with a pair of support legs 2027 and 2028 turned up rearward (see, e.g., the state illustrated in FIG. 8). As shown in FIG. 8, the rotational center or axis 2026b of the main stand 2026 can be provided above a lowest part 2024d of a lower surface of the exhaust chamber 2024. The main stand 2026 can be constructed such that a lowest part 2026c of the main stand 2026 is positioned above the lowest part 2024d of the exhaust chamber 2024 in the traveling state (the state of FIG. 8). In other words, the main stand 2026 can be constructed such that a whole of the main stand 2026 is positioned above the lowest part 2024d of the exhaust chamber 2024 in the traveling state.

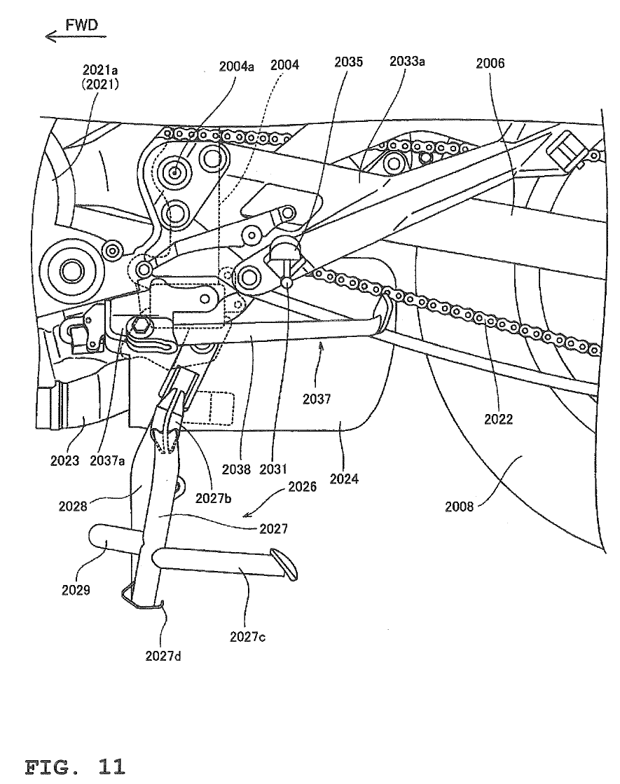

In the second exemplary embodiment, as shown in FIGS. 10 and 11, the main stand 2026 can include the pair of support legs 2027 and 2028 described above for supporting the vehicle in a stationary or standing-still state (e.g. a state as illustrated in FIG. 11) and a cross pipe 2029 for coupling the pair of support legs 2027 and 2028 together. The cross pipe 2029 may be referred to herein as a “coupling part.” As shown in FIG. 10, the support leg 2027 can be positioned on a side of the exhaust chamber 2024 in the direction of arrow X1, and the support leg 2028 can be positioned on a side of the exhaust chamber 2024 in the direction of arrow X2. In other words, the main stand 2026 can be constructed such that, in the traveling state (see FIGS. 8 and 10), components of the main stand 2026, such as the support legs 2027 and 2028, are respectively positioned outside, in the vehicle width direction (directions of arrows X1 and X2, respectively), of outer surfaces of the exhaust chamber 2024.

Referring now to FIGS. 7 and 10, one end of the support leg 2027 can be rotatably mounted on the mounting member 2010. Specifically, as shown in FIGS. 7 and 10, a bearing member 2027a can be mounted on the one end of the support leg 2027. The support leg 2027 can be fixed or fastened, for example, by one or more fixing or fastening members, such as a screw member 2050 and a nut 2051, with the bearing member 2027a inserted between a plate 2010a for one side and a plate 2010b for the other side of the mounting member 2010. As shown in FIG. 10, the support leg 2027 can be formed into a curved shape in which the other end (the end for contacting with the ground) curves outward (direction of arrow X1). A reinforcing member 2027b can be mounted on the curved part of the support leg 2027. This placement of the reinforcing member 2027b can be advantageous because a load of the vehicle 2001 may concentrate at the curved part in the standing-still state. An end of the cross pipe 2029 in the direction of arrow X1 can be fixed or fastened to, e.g., welded to, a vicinity of the other end (the end for contacting with the ground) of the support leg 2027. A side protruding member 2027c, for the rider to engage with his/her foot (e.g. to push) to easily turn or otherwise position the main stand 2026 to or in the standing-still state can be formed on, or fixed or fastened to, e.g., welded to, a vicinity of the part of the support leg 2027 to which the cross pipe 2029 is fastened.

A ground contacting plate 2027d which can contact with the ground with a surface can be mounted on the end of the support leg 2027 for contacting with the ground. As shown in FIG. 7, an end 2027e of the ground contacting plate 2027d can be formed to incline at an angle equal to or less than bank angle α1 described in more detail further on.

As shown in FIG. 10, one end of the support leg 2028 can be rotatably mounted on the mounting member 2011. Specifically, as shown in FIGS. 7 and 10, a bearing member 2028a can be mounted on the one end of the support leg 2028. The support leg 2028 can be fixed or fastened, for example, by one or more fixing or fastening members, such as a screw member 2052 and a nut 2053, with the bearing member 2028a inserted between a plate 2011a for one side and a plate 2011b for the other side of the mounting member 2011. As shown in FIG. 10, a spring mounting member 2028b extending in the direction of arrow X2 can be mounted between the one end and the other end of the support leg 2028. One end of a tension coil spring 2030 can be mounted on the spring mounting member 2028b. The other end of the tension coil spring 2030 can be connected to an end of the connecting member 2009 in the direction of arrow X2 via a member 2030a, which may, for example, be formed from sheet metal. The outermost part 2026a of the main stand 2026, as illustrated in FIG. 10, for example, may correspond to a part of the tension coil member 2030. As described above, the outermost part 2026a of the main stand 2026 can be positioned outside, in the direction of arrow X2, of the end 2024c of the exhaust outlet 2024b of the exhaust chamber 2024, and of the point 2025a of the cover member 2025. An end of the cross pipe 2029 in the direction of arrow X2 can be fixed or fastened to, e.g., welded, the support leg 2028 in a vicinity of the other end of the support leg 2028.

A ground contacting plate 2028c which can contact with the ground with a surface is mounted on the other end (the end contacting with the ground) of the support leg 2028. As shown in FIG. 7, an end 2028d of the ground contacting plate 2028c can be formed to incline at an angle equal to or less than bank angle α1 described later.

In the second exemplary embodiment, as shown in FIG. 8, the cross pipe 2029 can be positioned between the exhaust chamber 2024 and the rear wheel 2008 in the traveling state. Specifically, as shown in FIG. 7, a vicinity of a central part of the cross pipe 2029 in the vehicle width direction (directions of arrows X1 and X2) can extend downward in the traveling state. As shown in FIG. 8, the vicinity of the central part of the cross pipe 2029 in the vehicle width direction (directions of arrows X1 and X2) can be positioned in a lower part of the interval between the exhaust chamber 2024 and the rear wheel 2008, a region where the interval is wider than in an upper part, due to a rearward curvature of the wheel 2008 as it approaches a point where it contacts the ground. A lower end of the cross pipe 2029 can be positioned above a lower end of the exhaust chamber 2024. Therefore, decrease in the ground clearance of the motorcycle 2001 can be prevented even if the cross pipe 2029 extends downward as in the second exemplary embodiment.

As shown in FIG. 10, the cross pipe 2029 can at least partly overlap with the rear wheel 2008 in a plan view in the traveling state. Thus, the cross pipe 2029 can be formed to avoid a part protruding forward of the rear wheel 2008, by being positioned below the part protruding forward.

In the second exemplary embodiment, as shown in FIG. 7, vicinities of both ends of the cross pipe 2029 in the vehicle width direction (directions of arrows X1 and X2) can be formed to incline at inclination angles α2 and α3, respectively, that are equal to or less than the maximum leaning angle (bank angle α1) of the vehicle with respect to the vertical direction in the traveling state (e.g., a substantially up-and-down posture, with respect to the ground, assumed by the vehicle 2001 when it is moving or traveling). Thus, the cross pipe 2029 can avoid the part protruding forward of the rear wheel 2008 by being positioned below the part and at the same time can be formed within bank angle α1. It should be understood that inclination angles α1, α2 and α3 can be described as inclined inward (e.g., toward a center or vertical axis of FIG. 7).

In the second exemplary embodiment, bank angle α1 described above may be the maximum leaning angle of the vehicle in the case that the motorcycle 2001 is leaned in direction A1 or A2 in FIG. 7. Further, the motorcycle 2001 in accordance with the second exemplary embodiment can include bank sensors 2031 and 2032 for making the rider conscious of bank angle α1. Specifically, as shown in FIGS. 8 and 9, brackets 2033a and 2034a can be mounted on a pair of plate members 2033 and 2034 (see FIG. 7). Steps 2035 and 2036, on which the rider can place his/her feet, can be mounted on the brackets 2033a and 2034a, respectively. The steps 2035 and 2036 can be provided to extend in the directions of arrows X1 and X2, respectively. The bank sensors 2031 and 2032 can be mounted on lower parts of the steps 2035 and 2036, respectively. Each of the bank sensors 2031 and 2032 may be referred to herein as a “restraint member.”

As shown in FIG. 7, the bank sensor 2031 may first contact with the ground when the motorcycle 2001 is leaned in direction A1 in FIG. 7. Accordingly, the bank sensor 2031 can make the rider conscious of bank angle al (maximum leaning angle) of the vehicle with respect to the vertical direction when the vehicle is leaned in direction A1. The bank sensor 2032 may first contact with the ground when the motorcycle 2001 is leaned in direction A2 in FIG. 7. Thus, the bank sensor 2032 can make the rider conscious of bank angle α1 (maximum leaning angle) of the vehicle with respect to the vertical direction when the vehicle is leaned in direction A2.

As shown in FIG. 10, a side stand 2037 for supporting the vehicle in a leaned state can be mounted on an end of the connecting member 2009 in the direction of arrow X1. The side stand 2037 may be referred to herein as a “second stand.” The side stand 2037 can include a support leg 2038 and can rotate around one end of the support leg 2038. A spring mounting member 2038a can be mounted on a side of the support leg 2038 in the direction of arrow X2. One end of a tension coil spring 2039 can be mounted on the spring mounting member 2038a. The other end of the tension coil spring 2039 can rotatably retain the support leg 2038 and can be connected to a mounting member 2037a capable of mounting the side stand 2037 on the connecting member 2009.

In the second exemplary embodiment, as shown in FIG. 8, a lowest part 2037b of the side stand 2037 can be positioned above the lowest part 2026c of the main stand 2026 in the traveling state. As shown in FIG. 7, the side stand 2037 can be positioned above a borderline for bank angle α1 shown in FIG. 7 in the traveling state.

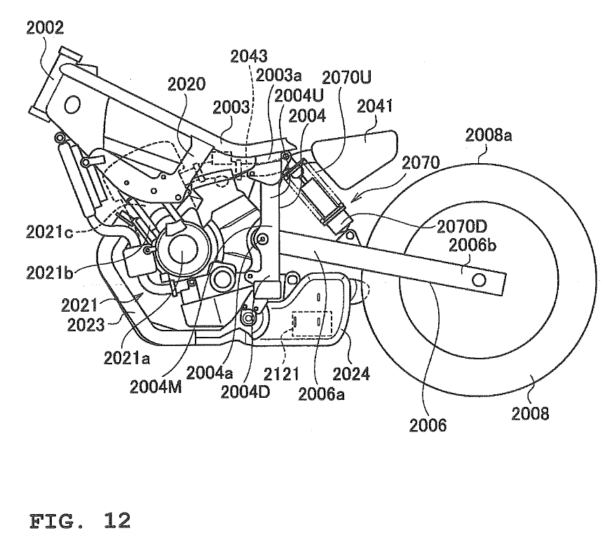

FIG. 12 is a left side view of a rear part of the motorcycle 2001. It should be understood that the motorcycle 2001 can include a vehicle body cover, not shown in FIG. 12, which would ordinarily cover at least a part of the motorcycle 2001 in the view of FIG. 12.

As shown in FIG. 12, the pivot supporting plate 2004 can extend in the vertical direction (e.g., a substantially up-and-down direction with respect to the orientation of the motorcycle 2001 as shown FIG. 12, or in as in a substantially upright posture for traveling), to the rear of the engine 2021. The pivot supporting plate 2004 can include an upper part 2004U for supporting a shock absorber 2070, an intermediate part 2004M for supporting the swing arm 2006, and a lower part 2004D for supporting the exhaust chamber 2024. The exhaust chamber 2024 can include a catalyst 2121.

The shock absorber 2070 can be supported by the upper part 2004U of the pivot supporting plate 2004 via a bracket 2003a. The pivot part 2004a can be provided in the intermediate part 2004M of the pivot supporting plate 2004. In other words, the pivot supporting plate 2004 can pivotably support the swing arm 2006. In the second exemplary embodiment, the pivot supporting plate 2004 and a part of the bracket 2003a can form a vertical frame part.

The swing arm 2006 can include a front part 2006a swingably supported by the pivot part 2004a, and a rear part 2006b supporting the rear wheel 2008.

An air cleaner 2041 can be disposed to the rear of the shock absorber 2070. The air cleaner 2041 can be provided above the swing arm 2006. The air cleaner 2041 can be disposed to the rear of the pivot supporting plate 2004.

More specifically, the air cleaner 2041 can be disposed to be adjacent to or adjoin an upper part 2070U of the shock absorber 2070 to the rear of the upper part 2070U. At least a part of the air cleaner 2041 can be provided below the upper part 2070U of the shock absorber 2070 and below an upper end 2008a of the rear wheel 2008. A lower part 2070D of the shock absorber 2070 can be coupled to the swing arm 2006. The air cleaner 2041 can be coupled to the cylinder head 2021c via an air intake 2043.

The exhaust chamber 2024 can be disposed below the shock absorber 2070. Further, the exhaust chamber 2024 can be provided between the pivot supporting plate 2004 and the rear wheel 2008 below the swing arm 2006.

Referring now to FIG. 10, in the second exemplary embodiment, as described above, the exhaust chamber 2024 can be provided such that the rear end 2024a is disposed in front of the rear wheel 2008. The cross pipe 2029 of the main stand 2026 can be positioned between the rear end 2024a of the exhaust chamber 2024 and the rear wheel 2008 in the traveling state. Thus, the main stand 2026 having the pair of support legs 2027 and 2028 can be provided to effectively use a small gap between the rear end 2024a of the exhaust chamber 2024 and the rear wheel 2008. Accordingly, in the case that the exhaust chamber 2024 is interposed between the engine 2021 and the rear wheel 2008, a stand can be provided that supports the motorcycle 2001 at two positions on both sides of the vehicle in the vehicle width direction.

In view of the foregoing discussion, embodiments of the invention have a number of advantages. For example, in the second exemplary embodiment, as described above, the main stand 2026 can be constructed such that the whole of the main stand 2026 is positioned above the lowest part 2024d of the exhaust chamber 2024 in the traveling state. Therefore, decrease in the ground clearance of the motorcycle 2001 can be prevented even if the main stand 2026 is provided.

Further, in the second exemplary embodiment, as described above, the main stand 2026 can be constructed such that both the ends of the main stand 2026 in the vehicle width direction (directions of arrows X1 and X2) are positioned outside, in the vehicle width direction, of outer surfaces of the exhaust chamber 2024 in the vehicle width direction. Thus, the main stand 2026 can be prevented from interfering with the lower surface of the exhaust chamber 2024 in the case that the main stand 2026 is turned upward in to the traveling state or position. The lowest part of the main stand 2026 can be positioned above the lowest part of the exhaust chamber, thereby forming the main stand 2026 so as to be positioned above the lowest part of the exhaust chamber 2024. With such an arrangement, the main stand 2026 can be positioned above the lowest part of the exhaust chamber 2024 without forming a recess in the exhaust chamber 2024. Therefore, decrease in the volume of the exhaust chamber 2024 can be prevented, while preventing decrease in the clearance from the main stand 2026 to the ground in the traveling state.

Still further, in the second exemplary embodiment, as described above, the vicinity of the central part of the cross pipe 2029 in the vehicle width direction (directions of arrows X1 and X2) extends downward in the traveling state. Accordingly, the cross pipe 2029 can be disposed to avoid the part protruding the most on the front side of the rear wheel 2008.

Still further, in the second exemplary embodiment, as described above, the vicinities of both the ends of the cross pipe 2029 of the main stand 2026 in the vehicle width direction (directions of arrows X1 and X2) can be formed to incline at inclination angles α2 and α3, respectively, that are equal to or less than the maximum leaning angle (bank angle α1) of the vehicle with respect to the vertical direction in the traveling state. Accordingly, the cross pipe 2029 of the main stand 2026 can allow prevention of decrease in bank angle α1 of the vehicle.

Still further, in the second exemplary embodiment, as described above, the rotational centers or axes 2026b of the main stand 2026 can be provided above the lowest part of the exhaust chamber 2024. Thus, the main stand 2026 can be easily disposed above the lowest part of the exhaust chamber 2024 in the case that the main stand 2026 is positioned in the traveling state.

Still further, in the second exemplary embodiment, as described above, the exhaust outlet 2024b can be provided to the rear of the exhaust chamber 2024 and between the main stand 2026 in the traveling state and the swing arm 2007. Accordingly, the exhaust outlet 2024b can be prevented from contacting with the rear wheel 2008 disposed in the rear of the exhaust chamber 2024. Further, burnt gases can be discharged with effective use of a space between the main stand 2026 and the swing arm 2007.

Still further, in the second exemplary embodiment, as described above, the lowest part 2037b of the side stand 2037 can be positioned above the lowest part 2026c of the main stand 2026 in the traveling state. Therefore, decrease in the ground clearance of the motorcycle 2001 can be prevented although the side stand 2037 is provided.

Still further, in the second exemplary embodiment, as described above, the end 2024c (the outermost part) of the exhaust outlet 2024b in the vehicle width direction (direction of arrow X2) can be positioned inside (in the direction of arrow X1) of the outermost part 2026a of the main stand 2026 in the vehicle width direction (direction of arrow X2). Accordingly, the main stand 2026 can protect the exhaust outlet 2024b from physical impacts from a side (from the direction of arrow X2).

### Other Embodiments

In the foregoing description of the first exemplary embodiment, the air cleaner 1041 can be disposed to the rear of the upper end 1070b of the shock absorber 1070. In alternative embodiments, the air cleaner 1041 can be disposed in front of or at the side of the upper end 1070b. Additionally, instead of being disposed to be adjacent to or adjoin the upper end 1070b of the shock absorber 1070 as described above, the air cleaner 41 can be remotely disposed from the upper end 1070b.

Further, in the above description of the first exemplary embodiment, the exhaust chamber 1120 can be disposed below the swing arm 1060. However, the exhaust chamber 1120 need not necessarily be disposed below the swing arm 1060.

Still further, in the above description of the first exemplary embodiment, the recess 1041a can be formed at the front end of the air cleaner 1041. However, the recess 1041a need not necessarily be formed at the front end of the air cleaner 1041. Additionally, in the above description of the first exemplary embodiment, the intake duct 1043 can be disposed on the left side of the recess 1041a. However, the intake duct 1043 can be disposed on the right side of the recess 1041a.

Still further, in the above description of the first exemplary embodiment, the lower end 1070a of the shock absorber 1070 can be directly coupled to the swing arm 1060 with no link mechanism interposed therebetween. However, the lower end 1070a can be coupled to the swing arm 1060 via a link mechanism.

Still further, in the above description of the first exemplary embodiment, the whole of the air cleaner 1041 can be provided above the swing arm 1060. However, alternatively, only a part of the air cleaner 1041 may be provided above the swing arm 1060. Moreover, in the above description of the first exemplary embodiment, the whole of the exhaust chamber 1120 can be provided below the swing arm 1060. However, alternatively, only a part of the exhaust chamber 1120 may be provided below the swing arm 1060.

Similarly, in the above description of the second exemplary embodiment, the whole of the air cleaner 2041 can be provided above the swing arm 2006. However, alternatively, only a part of the air cleaner 2041 may be provided above the swing arm 2006. Moreover, in the above description of the second exemplary embodiment, the whole of the exhaust chamber 2024 can be provided below the swing arm 2006. However, alternatively, only a part of the exhaust chamber 2024 may be provided below the swing arm 2006.

In the above description of the second exemplary embodiment, the side stand can be provided in addition to the main stand. However, alternatively, the main stand may be provided without the side stand.

Further, in the above description of the second exemplary embodiment, the vicinity of the central part of the cross pipe in the vehicle width direction can extend downward. However, alternatively, not only does the vicinity of the central part of the cross pipe in the vehicle width direction extend downward, but also the vicinities of both the ends of the cross pipe in the vehicle width direction may extend downward.

Still further, in the above description of the second exemplary embodiment, the exhaust outlet for discharging exhaust gas can be provided in the rear part of the exhaust chamber. However, alternatively, an exhaust outlet having functions for purifying exhaust gas discharged from the engine and for reducing exhaust noise may be additionally provided in a rear part of the exhaust chamber having the functions for purifying exhaust gas discharged from the engine and for reducing exhaust noise. In this case, an exhaust outlet having the functions for purifying exhaust gas discharged from the engine and for reducing exhaust noise may be provided to a whole of the exhaust outlet. As a still further alternative, the exhaust outlet having the functions for purifying exhaust gas discharged from the engine and for reducing exhaust noise may be provided in a part in front of the rear wheel

It should be understood that the first and second exemplary embodiments, or parts, components, alternatives, modifications, changes and adaptations thereof may be combined together.

It will be apparent to one skilled in the art that the manner of making and using the claimed invention has been adequately disclosed in the above-written description of the preferred embodiments taken together with the drawings.

It will be understood that the above description of the preferred embodiments of the present invention are susceptible to various modifications, changes and adaptations, and the same are intended to be comprehended within the meaning and range of equivalents of the appended claims.

1. A straddle-type vehicle comprising:
an engine;
a vehicle body frame supporting the engine;
a swing arm having a front part disposed to a rear of the engine and swingably supported by the vehicle body frame, and a rear part supporting a rear wheel;
a shock absorber having a lower part supported by the swing arm, and an upper part supported by the vehicle body frame and provided in front of the lower part;
an air cleaner disposed to a rear of the shock absorber and connected to the engine; and
an expansion chamber provided below the shock absorber and including a catalyst for purifying exhaust gas discharged from the engine,
wherein at least a part of the air cleaner is provided above the swing arm, and
at least a part of the expansion chamber is provided below the swing arm.

2. The straddle-type vehicle according to claim 1,
wherein the vehicle body frame includes a vertical frame part extending in a substantially vertical direction, and disposed to the rear of the engine,
the vertical frame part including:
an upper part supporting the shock absorber;
an intermediate part supporting the swing arm; and
a lower part supporting the expansion chamber;
wherein at least a part of the air cleaner is disposed to a rear of the vertical frame part.

3. The straddle-type vehicle according to claim 2,
wherein the swing arm has a right arm and a left arm, and
at least a part of the shock absorber is positioned between the right arm and the left arm in a plan view.

4. The straddle-type vehicle according to claim 3,
wherein at least a part of the air cleaner is provided below the upper part of the shock absorber and below an upper end of the rear wheel.

5. The straddle-type vehicle according to claim 4,
wherein at least a part of the expansion chamber is provided between the vehicle body frame and the rear wheel below the swing arm.

6. The straddle-type vehicle according to claim 1,
wherein the air cleaner is disposed to the rear of an upper end of the shock absorber.

7. The straddle-type vehicle according to claim 1,
wherein the air cleaner is adjacent to an upper end of the shock absorber.

8. The straddle-type vehicle according to claim 1,
wherein the shock absorber includes:
a cylindrical damper for reducing a shock to the rear wheel by reciprocal motion; and
a coil spring disposed around an outer periphery of the damper;
wherein the shock absorber is disposed such that a component of a direction in which the shock absorber is arranged is substantially vertical, and a recess curved along an outer peripheral shape of the shock absorber is formed at a front end of the air cleaner.

9. The straddle-type vehicle according to claim 8, further comprising an intake duct extending from the air cleaner toward the engine,
wherein the intake duct is disposed on a side of the recess.

10. The straddle-type vehicle according to claim 1,
wherein a lower end of the shock absorber is directly coupled to the swing arm with no link mechanism interposed therebetween.

11. The straddle-type vehicle according to claim 1, further comprising a first stand which includes a pair of support legs for supporting the vehicle in a standing-still state, and a coupling part coupling the pair of the support legs together, wherein the first stand is capable of being positioned into a traveling state;
wherein the expansion chamber is disposed to the rear of the engine and a rear end thereof is disposed in front of the rear wheel, and
the coupling part of the first stand is positioned between the rear end of the expansion chamber and the rear wheel in the traveling state.

12. The straddle-type vehicle according to claim 11,
wherein the first stand is constructed such that a whole thereof is positioned above a lowest part of the expansion chamber in the traveling state.

13. The straddle-type vehicle according to claim 11,
wherein the first stand is constructed such that respective ends of the first stand are positioned outside, in a vehicle width direction, of outer surfaces of the expansion chamber, and a lowest part of the first stand is positioned above a lowest part of the expansion chamber in the traveling state.

14. The straddle-type vehicle according to claim 11,
wherein a vicinity of a central part of the coupling part extends downward in the traveling state.

15. The straddle-type vehicle according to claim 11, further comprising a restraint member that contacts with the ground when the vehicle is leaned to make a rider conscious of a maximum leaning angle of the vehicle,
wherein vicinities of respective ends of the coupling part of the first stand in the vehicle width direction incline inward at an inclination angle equal to or less than the maximum leaning angle of the vehicle with respect to a substantially vertical direction.

16. The straddle-type vehicle according to claim 11,
wherein the coupling part of the first stand at least partly overlaps with the rear wheel in a plan view in the traveling state.

17. The straddle-type vehicle according to claim 11,
wherein the first stand has a rotational axis above a lowest part of the expansion chamber.

18. The straddle-type vehicle according to claim 11, further comprising an exhaust outlet disposed to the rear of the expansion chamber, and between the swing arm and the first stand in the traveling state.

19. The straddle-type vehicle according to claim 11, further comprising a second stand which includes a support leg provided on a side of the vehicle for supporting the vehicle in a leaned state while the vehicle stands still, and which can be positioned into the traveling state,
wherein a lowest part of the second stand is positioned above a lowest part of the first stand in the traveling state.

20. The straddle type vehicle according to claim 11, further comprising an exhaust outlet provided in a rear part of the expansion chamber,
wherein an outermost part of the exhaust outlet in a vehicle width direction is positioned inside of an outermost part of the first stand in the vehicle width direction.
